(19) United States
(12) Patent Application Publication
(10) Pub. No.: US 2020/0328814 A1
(43) Pub. Date: Oct. 15, 2020

(54) OPTICAL PACKAGING AND DESIGNS FOR OPTICAL TRANSCEIVERS

(71) Applicant: O-Net Communications (USA) Inc., San Jose, CA (US)

(72) Inventors: Xiaobing Luo, San Jose, CA (US); Zining Huang, San Jose, CA (US); Zhigang Zhou, San Jose, CA (US); Terrence Kerr, San Jose, CA (US); Qinrong Yu, San Jose, CA (US)

(21) Appl. No.: 16/862,437

(22) Filed: Apr. 29, 2020

Related U.S. Application Data
(63) Continuation of application No. PCT/US2018/058788, filed on Nov. 1, 2018.
(60) Provisional application No. 62/580,337, filed on Nov. 1, 2017.

(51) Int. Cl. H04B 10/40; H04J 14/02; H04B 10/50

(52) U.S. Cl. CPC H04B 10/40; H04B 10/503; H04J 14/0202

(57) ABSTRACT

Optical transceivers with optical packaging designs to reduce inside transceiver components, simplify the fabrication, and improve the optical alignment and other optical transceiver characteristics.

### PRIORITY CLAIM AND RELATED PATENT APPLICATION

The present application is a continuation of international PCT Application No. PCT/US2018/058788 filed on Nov. 1, 2018, and entitled “OPTICAL PACKAGING AND DESIGNS FOR OPTICAL TRANSCEIVERS,” Which claims the priority to and the benefits of U.S. Provisional Patent Application No. 62/580,337 entitled “OPTICAL PACKAGING AND DESIGNS FOR OPTICAL TRANSCEIVERS” and filed by Applicant O-Net Communications (USA) Inc. on Nov. 1, 2017.

### TECHNICAL FIELD

This patent document relates to optical transceivers in optical fiber communications.

### BACKGROUND

An optical transceiver is a device in fiber communications to transmit an output optical communication signal and to receive and convert an incoming optical communication signal into a received electrical signal for further processing. In some implementations, such an optical transceiver combines into one package an optical transmitter or a transmitter optical sub-assembly (TOSA), and an optical receiver or a receiver optical sub-assembly (ROSA). In commercial deployment, commercial optical transceivers may be designed as small form-factor pluggable transceivers that are can be plugged into standardized ports based on certain standards, such as, Small Form-Factor Pluggable (SFP) or Small Form-Factor Pluggable, Enhanced (SFP+) Multi-Source Agreements (MSAs). Those and other agreements in general define mechanical interfacing properties and electrical interfacing properties of the optical transceivers.

### SUMMARY

Optical transceivers are ubiquitous and important devices in optical fiber networks. In addition to meeting the specified features in standards, such as, MSAs, it is desirable that an optical transceiver is reliable in performance under varying operating conditions including temperature fluctuations. For example, it is desirable that an optical transceiver maintain a desired optical alignment over the product operational life to ensure the proper operation or performance of the optical transceiver. Optical transceivers may also be advantageously designed to reduce the number of optical elements to improve the device compactness, enhance the device reliability and to permit manufacturing of such devices at a relatively low cost.

The technology disclosed in this patent document can be used to provide optical transceiver designs with optical packaging features that enable both improved operational reliability, simplified optical alignment, and fabrication processes with reduced complexity.

For example, the disclosed technology can be implemented to construct an optical transceiver that includes a printed circuit board; an optical transmitter engaged to the printed circuit board to produce an output optical communication signal that combines different optical signals at different laser wavelengths; and an optical receiver engaged to the printed circuit board to receive an input optical communication signal. In this optical transceiver, the optical transmitter includes a transmitter support bench engaged to the printed circuit board; different semiconductor laser assemblies engaged to the transmitter support bench to emit laser beams at the different laser wavelengths to carry communication signals at the different laser wavelengths; a wavelength multiplexing device engaged to the transmitter support bench and located to receive the laser beams from the semiconductor laser assemblies and to combine the different laser beams into a combined output laser beam as an output of the optical transceiver; and an optical isolator located relative to the wavelength multiplexing device to receive the combined output laser beam while preventing light propagating in a direction opposite to the combined output laser beam, thus reducing undesired optical feedback to the wavelength multiplexing device and the semiconductor laser assemblies without having individual optical isolators designated for the semiconductor laser assemblies, respectively.

For another example, the disclosed technology can be implemented to construct an optical transceiver that includes a printed circuit board; an optical transmitter engaged to the printed circuit board to produce an output optical communication signal that combines different optical signals at different laser wavelengths; and an optical receiver engaged to the printed circuit board to receive an input optical communication signal. In this optical transceiver, the optical transmitter includes a transmitter support bench engaged to the printed circuit board; different semiconductor laser assemblies engaged to the transmitter support bench to emit laser beams at the different laser wavelengths to carry communication signals at the different laser wavelengths; and a wavelength multiplexing device engaged to the transmitter support bench and located to receive the laser beams from the semiconductor laser assemblies and to combine the different laser beams into a combined output laser beam. In addition, each semiconductor laser assembly includes a laser assembly mount; a diode laser chip engaged to the laser assembly mount; a laser driver circuit engaged to the laser assembly mount and electrically coupled to the diode laser chip to supply electrical power to the diode laser chip to cause generation of laser light; and a lens engaged to the laser assembly mount at a fixed position from the diode laser chip to receive laser light emitted from the diode laser chip and to shape the laser light into a laser beam that is directed towards the wavelength multiplexing device so that common engagement of the lens and the diode laser chip to the laser assembly mount enhances stability of optical alignment of the semiconductor laser assembly.

For yet another example, the disclosed technology can be implemented to provide a method for operating an optical transceiver in optical communications based on wavelength division multiplexing (WDM). This method includes operating different semiconductor laser assemblies on a common optical transmitter support bench to produce different WDM channel laser beams by placing an optical lens and a diode laser chip onto a common laser assembly mount, in each semiconductor laser assembly, to enhance stability of optical alignment of the semiconductor laser assembly; providing a wavelength multiplexing device engaged to the optical transmitter support bench to receive the different WDM channel laser beams from the semiconductor laser assemblies and to combine the different WDM channel laser beams into a combined output laser beam as an output of the optical transceiver; placing different optical filters in optical paths between the different semiconductor laser assemblies and the wavelength multiplexing device to reduce optical cross talk between the different WDM channel laser beams received by the wavelength multiplexing device; using a single optical isolator to receive the combined output laser beam from the wavelength multiplexing device to prevent light propagating in a direction opposite to the combined output laser beam, thus reducing undesired optical feedback to the wavelength multiplexing device and the semiconductor laser assemblies; and placing an optical wavelength demultiplexing device and an array of photodetectors on a common receiver bench to receive incoming WDM channel laser beams by the optical wavelength demultiplexing device to separate the received incoming WDM channel laser beams for optical detection by the photodetectors as part of receiver operation of the optical transceiver.

The above and other features, examples and their implementations are described in greater detail in the description, the drawings, and the claims.

### BRIEF DESCRIPTION OF DRAWINGS

FIGS. 1 and 2 show examples of components of small form factor pluggable transceivers that can implement features of the disclosed technology. FIG. 2 includes FIGS. 2A through 2E. FIGS. 2A and 2B show the optical transmitter TX module and the optical receiver module, respectively, which are further illustrated in FIGS. 3, 6A and 6B. FIG. 2C shows a top view of the PCB board on which the optical TX and RX modules are mounted. FIG. 2D shows the optical transceiver housing without the housing cover. FIG. 2E shows the PCB board with optical TX and RX modules mounted and coupled to the input and output fiber lines or cables. FIG. 2F shows the interior of the optical transceiver without the housing cover and FIG. 2G shows the fully assembled optical transceiver with the housing cover.

FIG. 3 shows examples of design features for an optical transmitter in optical transceivers based on the disclosed technology.

FIG. 4, including FIGS. 4A and 4B, shows one example of engaging a lens and a laser onto a common platform of an optical transmitter within an optical transceiver.

FIG. 5 shows one example of a heat sink design for an optical transmitter within an optical transceiver. FIG. 5 includes FIGS. 5A-5E where FIGS. 5A and 5B show side and top views of the optical transceiver PCB board with the head sink and FIGS. 5C, 5D and SE show different views of photographs of the example device.

FIG. 6, including FIGS. 6A and 6B, shows an example of placing different optical components onto a common platform of an optical receiver.

### DETAILED DESCRIPTION

Optical transceivers for optical wavelength-division multiplexing (WDM) need to integrate different lasers for emitting laser light at the different WDM wavelengths in an optical transmitter part of a transceiver. For each optical WDM channel, optical alignment is required to direct the laser beam along the desired optical path. However, it can be technically challenging to maintain the desired optical alignment when different optical elements are placed at different parts of the transceiver due to shifts in positions caused by non-uniform temperature distribution and materials' thermal expansion mismatch. The disclosed technology in this document provides optical designs and packaging to strategically place certain optical elements on a common platform to reduce changes in their relative positions, thus improving the stability of optical alignment. In addition, handling laser light at different optical WDM wavelengths generally necessitates processing of different signals at the different WDM wavelengths separately so that different optical WDM channels have different sets of optical components as in many optical transceiver designs. The disclosed technology can be implemented to share certain optical components for different optical WDM channels to reduce the number of the optical components in each transceiver and associated optical assignment issues. The examples for designing optical transceivers provided below illustrate those and other features in optical packaging.

The disclosed technology can be implemented in various applications for using optical WDM transceivers, such as, combining four 25 G CWDM4 optical transceivers (e.g., 1271 nm, 1291 nm, 1311 nm, and 1331 nm) for providing, 100 G ports for interconnections in datacenters, such as, 2 KM interconnections.

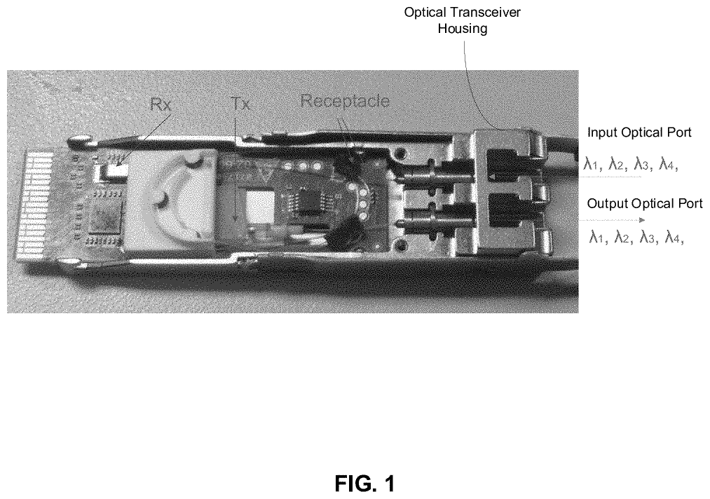

FIG. 1 shows example of a small form factor pluggable transceiver that can implement features of the disclosed technology. In this particular example, the transceiver is a 4-channel WDM transceiver having an optical transmitter marked by “TX” and an optical receiver marked by “RX” and the optical input/output interface on the right-hand side (optical WDM input and output ports and fiber lines) and the electrical input/output port with input/output electrodes on the left-hand side. FIG. 1 further shows an example of a portion of the optical transceiver housing without the housing cover to illustrate the layout inside the optical transceiver.

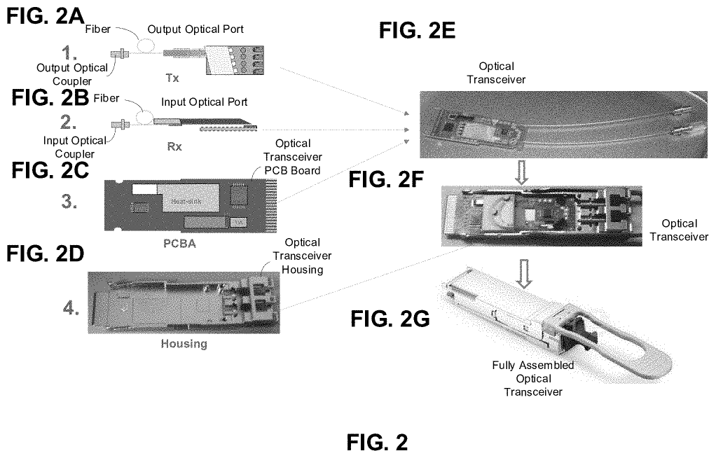

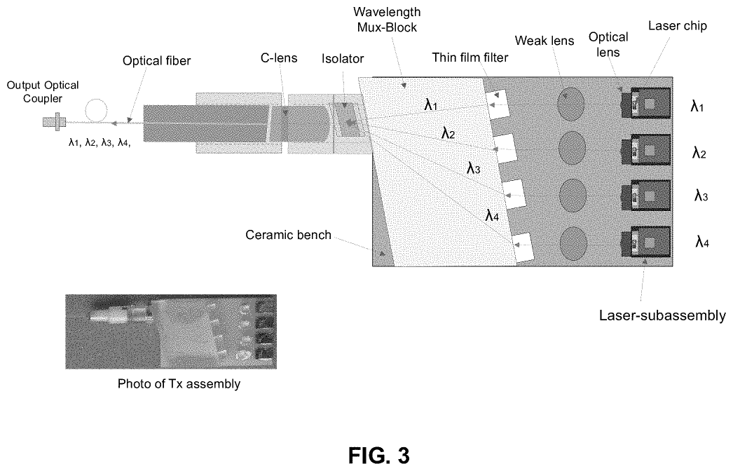

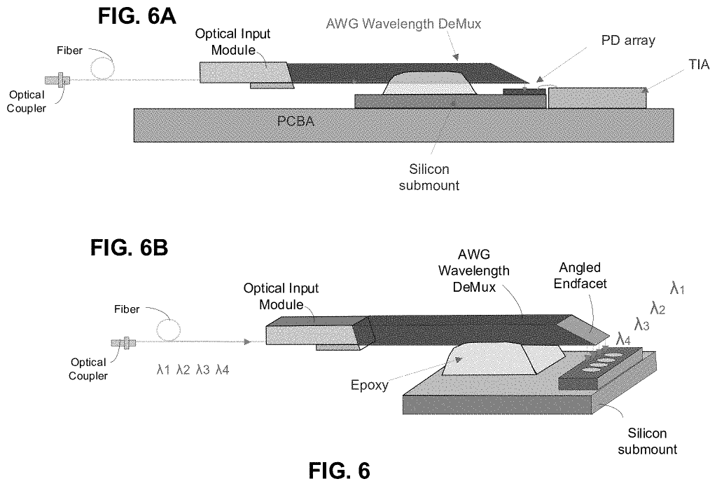

FIG. 2 shows examples of different components of the optical transceiver in FIG. 1 and an example for arranging the components, including the printed circuit board (PCB) for supporting the optical transmitter (TX) and optical receiver (RX) modules and other components. This example optical transceiver includes an optical transmitter engaged to the printed circuit board to produce an output optical communication signal that combines different optical signals at different laser wavelengths and an optical receiver engaged to the printed circuit board to receive an input optical communication signal. FIGS. 2A and 2B show the optical transmitter TX module and the optical receiver module, respectively, which are further illustrated in FIGS. 3, 6A and 6B. FIG. 2C shows a top view of the PCB board on which the optical TX and RX modules are mounted. FIG. 2D shows the optical transceiver housing without the housing cover. FIG. 2E shows the PCB board with optical TX and RX modules mounted and coupled to the input and output fiber lines or cables. FIG. 2F shows the interior of the optical transceiver without the housing cover and FIG. 2G shows the fully assembled optical transceiver with the housing cover.

FIG. 3 shows examples of design features for an optical transmitter in optical transceivers based on the disclosed technology shown in FIGS. 1 and 2. The output optical port is illustrated on the left-hand side of the optical transmitter in FIG. 3 with a fiber collimator lens assembly (C-lens) for coupling to the receiving end of a fiber and an output optical coupler coupled to the outputting end of the fiber. A transmitter support bench is provided as a common platform onto which different components of the transmitter are mounded or fixed. In this optical transceiver, the optical transmitter includes a transmitter support bench engaged to the printed circuit board: four different semiconductor laser assemblies as shown on the right-hand side that are engaged to the transmitter support bench to emit laser beams at the different laser wavelengths to carry communication signals at the different laser wavelengths, a wavelength multiplexing device engaged to the transmitter support bench and located to receive the laser beams from the semiconductor laser assemblies and to combine the different laser beams into a combined output laser beam as an output of the optical transceiver, and an optical isolator located relative to the wavelength multiplexing device (e.g., between the fiber collimator lens and the output port of the wavelength multiplexing device) to receive the combined output laser beam while preventing light propagating in a direction opposite to the combined output laser beam. This use of a single optical isolator in the illustrated design in FIG. 3 is used to reduce undesired optical feedback to the output optical port of the combined output laser beam of the wavelength multiplexing device so that the optical feedback to each of the semiconductor laser assemblies can be reduced. This design avoids having individual optical isolators designated for the different semiconductor laser assemblies, respectively.

FIG. 3 shows that four optical stability lenses, each labeled as “weak lens”, are engaged to the transmitter support bench and are respectively located in optical paths of the laser beams between the semiconductor laser assemblies and input optical ports of the wavelength multiplexing device. Each optical stability lens is structured to produce a lensing effect on laser light at a corresponding designated laser wavelength for a corresponding semiconductor laser assembly associated to spatially stabilize the alignment of the laser beam when being coupled into a corresponding input port of the wavelength multiplexing device. The optical power of such a lens tends to be low in implementations.

FIG. 3 further shows an optical filtering design in an optical transmitter by including different optical filters that are respectively located in optical paths of the laser beams from the semiconductor laser assemblies to the input ports of the wavelength multiplexing device. Each optical filter is fixed in position relative to the transmitter support bench in a corresponding optical path and structured to transmit light at a corresponding designated laser wavelength for a corresponding semiconductor laser assembly associated with the corresponding optical path while rejecting light at other wavelengths. This optical filtering reduces cross talk between different optical WDM channels. In the illustrated example, each optical filter in the optical transmitter includes a thin film optical bandpass filter but other filter implementations are possible. In operation, the laser beams at the different WDM channels from the semiconductor laser assemblies or laser chips are directed via their respective optical lenses to the optical filters so that only the desired light at the WDM channel wavelengths pass through the optical filters, respectively, and enter the wavelength multiplexer (“Wavelength Mux-Block”) which combines the different WDM channel beams into a single beam for output transmission. In this example, the wavelength multiplexer is an optical wedge with a slanted input surface to cause bending of the different WDM channel beams so that the different WDM channel beams are directed towards a common location on the other optical surface of the optical wedge to be combined. A common optical isolator is placed near the other optical surface of the optical edge to receive the combined optical beam having the different WDM channel beams and the optical output of the common optical isolator is directed into the C-lens and the output optical fiber line. The insert in FIG. 3 is a photograph of a sample device.

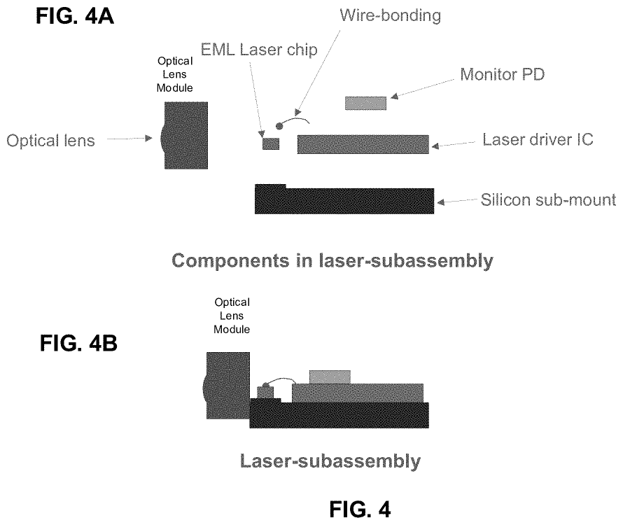

FIG. 4 includes FIGS. 4A and 4B and shows one example of engaging a lens and a laser onto a common platform of an optical transmitter within an optical transceiver. FIG. 4A shows an example of a semiconductor laser assembly for an optical transmitter. This example includes a laser assembly mount, such as, a silicon sub mount, a diode laser chip engaged to the laser assembly mount, a laser driver circuit engaged to the laser assembly mount and electrically coupled to the diode laser chip (e.g., by wire bonding) to supply electrical power to the diode laser chip to cause generation of laser light, and a lens module engaged to the laser assembly mount at a fixed position from the diode laser chip to receive laser light emitted from the diode laser chip and to shape the laser light into a laser beam that is directed towards the wavelength multiplexing device. This common engagement of the lens module and the diode laser chip to the laser assembly mount enhances stability of optical alignment of the semiconductor laser assembly. FIG. 4A is an exploded view of the components of such an optical transmitter and FIG. 4B is a view of the assembled optical transmitter. In this example, a monitor photo detector (PD) such as a photodiode, is provided to receive a portion of the laser output from the laser chip for measuring the optical power of the output laser light and is mounted above the laser drive IC.

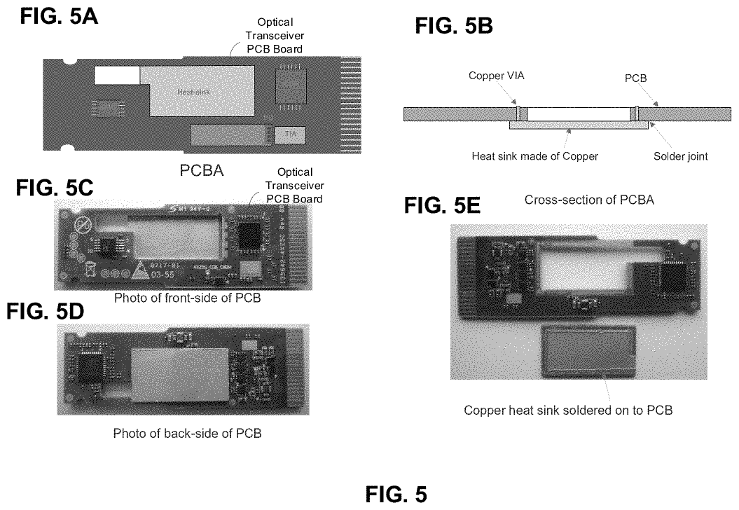

FIG. 5 shows one example of a heat sink design for an optical transmitter within an optical transceiver. FIGS. 5A and 5B show side and top views of the optical transceiver PCB board with the head sink. In this example, the heat sink is coupled to the transmitter support bench to transfer heat generated by the semiconductor laser assemblies out of the optical transmitter. Specifically, the heat sink includes a copper plate located on an opposite of the printed circuit board and includes electrical conductive vias (e.g., copper vias) in contact with the transmitter support bench to transfer heat generated by the semiconductor laser assemblies out of the optical transmitter. FIGS. 5C, 5D and 5E show different views of photographs of a sample device.

FIG. 6 includes FIGS, 6A and 6B and shows an example design which places different optical components onto a common platform of an optical receiver of an optical transceiver based on the disclosed technology. To illustrate the spatial relationships of different components, FIG. 6A shows a side view and FIG. 6B shows a prospective view. The optical receiver includes a receiver support bench (e.g., the silicon submount) that is engaged to the printed circuit board; a wavelength demultiplexing device engaged to the receiver support bench and structured to receive the input optical communication signal via an optical input module coupled to an input fiber line and to separate the input optical communication signal into different input laser beams at different receiver laser wavelengths; and an array of photodetectors engaged to the receiver support bench and positioned relative to the wavelength demultiplexing device to receive the different input laser beams at different receiver laser wavelengths, respectively. The wavelength demultiplexing device can be implemented as an arrayed waveguide gratings (AWG) module or other demultiplexing devices. The AWG can be engaged to the receiver support bench by epoxy or other engagement methods. In some implementations, the array of photodetectors can be a 1-dimensional array of photodetector in form a photodetector chip which is engaged to the receiver support bench. The detector circuit for processing the detector outputs is engaged to the printed circuit board and electrically coupled to the array of photodetectors to receive the detector outputs from the photodetectors. The detector circuit can include an amplifier (e.g., transimpedance amplifier (TIA)) and other circuitry elements. In the illustrated AWG example, the AWG includes an output facet that is angled to reflect demultiplexed WDM channel beams towards their respective photodetectors.

In the above examples, the optical transmitter and the receiver assemblies can be designed to be directly attached to the PCB. In some implementations, the optical transmitter and receiver assemblies may not be hermetically sealed optical components to reduce the component complexity and to reduce the overall cost. In addition, in some implementations, laser welding may not be used during the assembly process to simplify the fabrication.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Only a few implementations and examples are described, and other implementations, enhancements, and variations can be made based on what is described and illustrated in this patent document.

What is claimed is:

1. An optical transceiver, comprising:
a printed circuit board;
an optical transmitter engaged to the printed circuit board to produce an output optical communication signal that combines different optical signals at different laser wavelengths; and
an optical receiver engaged to the printed circuit board to receive an input optical communication signal,
wherein the optical transmitter includes:
a transmitter support bench engaged to the printed circuit board,
different semiconductor laser assemblies engaged to the transmitter support bench to emit laser beams at the different laser wavelengths to carry communication signals at the different laser wavelengths,
a wavelength multiplexing device engaged to the transmitter support bench and located to receive the laser beams from the semiconductor laser assemblies and to combine the different laser beams into a combined output laser beam as an output of the optical transceiver, and
an optical isolator located relative to the wavelength multiplexing device to receive the combined output laser beam while preventing light propagating in a direction Opposite to the combined output laser beam, thus reducing undesired optical feedback to the wavelength multiplexing device and the semiconductor laser assemblies without having individual optical isolators designated for the semiconductor laser assemblies, respectively.

2. The optical transceiver as in claim 1, wherein the optical transmitter further includes:
different optical filters respectively located in optical paths of the laser beams from the semiconductor laser assemblies between the wavelength multiplexing device and the wavelength multiplexing device, each optical filter fixed relative to the transmitter support bench in a corresponding optical path and structured to transmit light at a corresponding designated laser wavelength for a corresponding semiconductor laser assembly associated with the corresponding optical path while rejecting light at other wavelengths.

3. The optical transceiver as in claim 2, wherein each optical filter in the optical transmitter includes a thin film optical bandpass filler,

4. The optical transceiver as in claim 1, wherein the transmitter support bench is a ceramic bench.

5. The optical transceiver as in claim 1, wherein each semiconductor laser assembly includes:
a laser assembly mount;
a diode laser chip engaged to the laser assembly mount;
a laser driver circuit engaged to the laser assembly mount and electrically coupled to the diode laser chip to supply electrical power to the diode laser chip to cause generation of laser light; and
a lens engaged to the laser assembly mount at a fixed position from the diode laser chip to receive laser light emitted from the diode laser chip and to shape the laser light into a laser beam that is directed towards the wavelength multiplexing device,
wherein common engagement of the lens and the diode laser chip to the laser assembly mount enhances stability of optical alignment of the semiconductor laser assembly.

6. The optical transceiver as in claim 5, wherein each semiconductor laser assembly includes:
a photodetector engaged to the laser assembly mount and positioned relative to the diode laser chip to receive and detect a portion of laser light from the diode laser chip to monitor laser power of the diode laser chip.

7. The optical transceiver as in claim 5, wherein the optical transmitter includes:
optical stability lenses engaged to the transmitter support bench and respectively located in optical paths of the laser beams between the semiconductor laser assemblies and the wavelength multiplexing device, each optical stability lens in a corresponding optical path structured to produce a lensing effect on laser light at a corresponding designated laser wavelength for a corresponding semiconductor laser assembly associated with the corresponding optical path to spatially stabilize the laser beam.

8. The optical transceiver as in claim 1, further comprising:
a heat sink coupled to the transmitter support bench to transfer heat generated by the semiconductor laser assemblies out of the optical transmitter.

9. The optical transceiver as in claim 8, wherein the heat sink includes a copper plate located on an opposite of the printed circuit board and includes electrically conductive vias in contact with the transmitter support bench to transfer heat generated by the semiconductor laser assemblies out of the optical transmitter.

10. The optical transceiver as in claim 1, wherein the optical receiver includes:
a receiver support bench that is engaged to the printed circuit board;
a wavelength demultiplexing device engaged to the receiver support bench and structured to receive the input optical communication signal and to separate the input optical communication signal into different input laser beams at different receiver laser wavelengths;
an array of photodetectors engaged to the receiver support bench and positioned relative to the wavelength demultiplexing device to receive the different input laser beams at different receiver laser wavelengths, respectively; and
a detector circuit engaged to the printed circuit board and electrically coupled to the an array of photodetectors to receive detector outputs from the photodetectors.

11. An optical transceiver, comprising:
a printed circuit board;
an optical transmitter engaged to the printed circuit board to produce an output optical communication signal that combines different optical signals at different laser wavelengths; and
an optical receiver engaged to the printed circuit board to receive an input optical communication signal,
wherein the optical transmitter includes:
a transmitter support bench engaged to the printed circuit board;
different semiconductor laser assemblies engaged to the transmitter support bench to emit laser beams at the different laser wavelengths to carry communication signals at the different laser wavelengths; and
a wavelength multiplexing device engaged to the transmitter support bench and located to receive the laser beams from the semiconductor laser assemblies and to combine the different laser beams into a combined output laser beam; and
wherein each semiconductor laser assembly includes:
a laser assembly mount;
a diode laser chip engaged to the laser assembly mount;
a laser driver circuit engaged to the laser assembly mount and electrically coupled to the diode laser chip to supply electrical power to the diode laser chip to cause generation of laser light; and
a lens engaged to the laser assembly mount at a fixed position from the diode laser chip to receive laser light emitted from the diode laser chip and to shape the laser light into a laser beam that is directed towards the wavelength multiplexing device,
wherein common engagement of the lens and the diode laser chip to the laser assembly mount enhances stability of optical alignment of the semiconductor laser assembly.

12. The optical transceiver as in claim 11, wherein the optical transmitter further includes:
different optical filters respectively located in optical paths of the laser beams from the semiconductor laser assemblies between the wavelength multiplexing device and the wavelength multiplexing device, each optical filter fixed relative to the transmitter support bench in a corresponding optical path and structured to transmit light at a corresponding designated laser wavelength for a corresponding semiconductor laser assembly associated with the corresponding optical path while rejecting light at other wavelengths.

13. The optical transceiver as in claim 12, wherein each optical filter in the optical transmitter includes a thin film optical bandpass filter.

14. The optical transceiver as in claim 12, wherein each semiconductor laser assembly includes:
a photodetector engaged to the laser assembly mount and positioned relative to the diode laser chip to receive and detect laser light from the diode laser chip to monitor laser power of the diode laser chip.

15. The optical transceiver as in claim 11, wherein the optical transmitter includes:
optical stability lenses engaged to the transmitter support bench and respectively located in optical paths of the laser beams from the semiconductor laser assemblies, each optical stability lens in a corresponding optical path structured to produce a lensing effect on laser light at a corresponding designated laser wavelength for a corresponding semiconductor laser assembly associated with the corresponding optical path to spatially stabilize the laser beam.

16. The optical transceiver as in claim 11, further comprising:
a heat sink coupled to the transmitter support bench to transfer heat generated by the semiconductor laser assemblies out of the optical transmitter.

17. The optical transceiver as in claim 16, wherein the heat sink includes a copper plate located on an opposite of the printed circuit board and includes copper vias in contact with the transmitter support bench to transfer heat generated by the semiconductor laser assemblies out of the optical transmitter.

18. The optical transceiver as in claim 11, wherein the optical receiver includes:
a receiver support bench that is engaged to the printed circuit board;
a wavelength demultiplexing device engaged to the receiver support bench and structured to receive the input optical communication signal and to separate the input optical communication signal into different input laser beams at different receiver laser wavelengths;
an array of photodetectors engaged to the receiver support bench and positioned relative to the wavelength demultiplexing device to receive the different input laser beams at different receiver laser wavelengths, respectively; and
a detector circuit engaged to the printed circuit board and electrically coupled to the an array of photodetectors to receive detector outputs from the photodetectors.

19. A method for operating an optical transceiver in optical communications based on wavelength division multiplexing (WDM), comprising:
operating different semiconductor laser assemblies on a common optical transmitter support bench to produce different WDM channel laser beams by placing an optical lens and a diode laser chip onto a common laser assembly mount, in each semiconductor laser assembly, to enhance stability of optical alignment of the semiconductor laser assembly;
providing a wavelength multiplexing device engaged to the optical transmitter support bench to receive the different WDM channel laser beams from the semiconductor laser assemblies and to combine the different WDM channel laser beams into a combined output laser beam as an output of the optical transceiver;
placing different optical filters in optical paths between the different semiconductor laser assemblies and the wavelength multiplexing device to reduce optical cross talk between the different WDM channel laser beams received by the wavelength multiplexing device;
using a single optical isolator to receive the combined output laser beam from the wavelength multiplexing device to prevent light propagating in a direction opposite to the combined output laser beam, thus reducing undesired optical feedback to the wavelength multiplexing device and the semiconductor laser assemblies; and
placing an optical wavelength demultiplexing device and an array of photodetectors on a common receiver bench to receive incoming WDM channel laser beams by the optical wavelength demultiplexing device to separate the received incoming WDM channel laser beams for optical detection by the photodetectors as part of receiver operation of the optical transceiver.

20. The method as in claim 19, comprising operating a heat sink that includes a copper plate and one or more copper contacts in contact with the optical transmitter support bench to transfer heat generated by the semiconductor laser assemblies to the copper plate for dissipation.
